(19) United States
(12) Patent Application Publication
(10) Pub. No.: US 2009/0250082 A1
(43) Pub. Date: Oct. 8, 2009

(54) CONVEYOR DEBRIS WASHING APPARATUS AND METHODS

(76) Inventor: Edward B. Miller, Naples, FL (US)

Correspondence Address: HAHN LOESER & PARKS, LLP, One GOJO Plaza, Suite 300, AKRON, OH, 44311-1076, US

(21) Appl. No.: 12/366,899

(22) Filed: Feb. 6, 2009

Related U.S. Application Data
(60) Provisional application No. 61/026,847, filed on Feb. 7, 2008.

(51) Int. Cl. B08B 3/04

(52) U.S. Cl. 134/10; 134/104.4

(57) ABSTRACT

The invention relates to systems and methods that remove debris from conveyor systems, such as swarf conveyors used in machining operations. In an example, the invention relates to swarf conveyor cleaning and collecting systems and methods, or may be generally applicable for operation with other conveyor systems and environments. The washing system according to an example is positioned in association with a swarf conveyor adjacent the discharge end of the conveyor and at a position adjacent the return path immediately after the conveyor discharge end. The washing systems may be used in a variety of industries and applications, for example, metal machining operations, agricultural operations, food operations, recycling operations, lumber operations, or other operations using a conveyor system to move or remove products which can be undesirably retained on the conveyor system.

### CROSS-REFERENCE TO RELATED APPLICATIONS

This patent application claims the benefit of U.S. Provisional Patent Application No. 61/026,847, filed Feb. 7, 2008, the disclosure of which is expressly incorporated by reference herein.

### FIELD OF THE INVENTION

The present invention relates to industrial conveyor equipment, and more particularly to an apparatus for washing unwanted conveyor debris from a conveyor belt. The invention further relates to systems and methods for cleaning or washing debris from a conveyor belt, such as relating to swarf which collects on a conveyor system. The systems and methods clean swarf from the conveyor to remove it from the conveyor prior to the return of the conveyor to a reservoir to alleviate contamination of the fluid in the reservoir and to remove swarf which can cause excessive conveyor motor and drive component loading.

### BACKGROUND OF THE INVENTION

In various applications, conveyor systems are used to move products between locations, or to remove products from a location. For example, various industries use computer numerical control (CNC) equipment, where a computer “controller” reads code commands and drives a machine tool or powered mechanical device used to fabricate components by the selective removal of material. Such equipment includes routers, lathes, drills, mills and other machinery having specially configured cutting bits to shape metal work pieces by removing metal therefrom. The metal turnings or chips which are removed come in many different shapes and sizes, and are collectively referred to as swarf. Such debris can be gathered, and possibly recycled or disposed of. The swarf is generated at the location of machining and typically flushed away from the work piece by machining fluids used in the machining process. To cool work pieces and machine cutting tools and to flush swarf away from cutting bits during machining, a liquid coolant flows at or near the cutting bits. The swarf generally therefore has coolant fluids on its surfaces, and the coolant also helps in cooling the swarf after it is flushed away from the work piece.

Swarf may be removed from the machining station via swarf conveyor belts that are driven by a motor and move the swarf away from the site of machining to be gathered for recycling or disposal. During machining, the conveyor belt may be driven to convey swarf from machine work stations. To remove swarf from machining stations, a conveyor belt may be positioned below or adjacent a machine or machine line to catch flushed swarf, and convey the swarf to a collection bin at the end of the conveyor belt. Some such conveyor systems include an upwardly directed section which conveys the swarf upwardly at an inclined angle (e.g. 45 degrees) to then be dumped into a large bin located at its inclined end, thereby allowing the use of large collection bins. To maintain swarf on the conveyor belt during conveying, a conveyor housing may be provided. The conveyor housing may also form a reservoir for the coolant fluids used in the machining processes, where the coolant fluids are caught and drip or flow back to the coolant reservoir for further use in a recirculating manner. Upon being flushed onto the conveyor system, the coolant on the surfaces of the swarf may cause it to stick to the conveyor belt such that it is circulated with the conveyor belt, and causing it not to fall off into the collection bin. Such swarf may then be circulated back to the coolant reservoir. This can result in various problems, including causing contamination or degradation of the coolant in the reservoir. The swarf, which may still be hot, can cause burning or degradation of the coolant fluids in the reservoir. Such degradation of the coolant fluids can lead to having to treat the fluids as a hazardous material, thereby greatly increasing the cost of handling and disposal. Further, if the swarf fall offs the conveyor into the reservoir, it can potentially clog the pumping and piping systems used to supply coolant to the machining area. The sticking of swarf on the conveyor system may also cause excessive loading of the conveyor and of the drive motor and system, or interfere with proper movement of the conveyor.

There thus exists a need for a system that will alleviate swarf retained on such conveyor systems and that protect the conveyor system and coolant fluids used in a machining operation. Similarly, in other environments where conveyors are used, such as with recycling, agricultural or food processing systems, retained materials on conveyor systems can also cause problems, and it would be desirable to provide systems and methods that would remove debris from such conveyor systems in a simple and effective manner.

### SUMMARY OF THE INVENTION

The present invention is therefore directed to systems and methods that remove debris from conveyor systems, such as swarf conveyors used in machining operations. The problems with the operation of the conveyor systems described above can be addressed by providing a washing or cleaning system and process that positively dislodges retained materials and debris on a conveyor system and removes the materials from the conveyor system. In an example, the invention relates to swarf conveyor cleaning and collecting systems and methods, or may be generally applicable for operation with other conveyor systems and environments. The washing system according to an example is positioned in association with a swarf conveyor adjacent the exit end of the conveyor system and at a position immediately after the conveyor system path is made to return. The invention in an example provides a swarf conveyor debris washing apparatus to remove the debris that remains on the conveyor from a metal machining operation, and prevents the swarf, cuttings or filings from contaminating the coolant solution used in the machining operation. The invention also relates to a method of washing debris from a conveyor system and collecting debris to avoid interference with conveyor operation or other processes in an application or environment. The present invention relates to systems and methods for washing conveyor systems which may be used in a variety of industries and applications, for example, metal machining operations, agricultural operations, food operations, recycling operations, lumber operations, or other operations using a conveyor system to move or remove products which can be undesirably retained on the conveyor system.

These and other aspects of the invention will become apparent from the following description in conjunction with the accompanying drawings which show examples of the invention. The examples as shown and described do not necessarily represent the full scope of the invention, and reference should only be made to the claims which define the scope of the invention.

### BRIEF DESCRIPTION OF THE DRAWINGS

FIG. 1 shows a schematic illustration of a conveyor system with a conveyor washing apparatus, in accordance with an example of the subject invention.

FIG. 2 shows a partial illustration of the conveyor system and the conveyor washing apparatus of FIG. 1.

FIG. 3 shows a cross sectional view of the housing associated with the conveyor washing apparatus of FIG. 1.

FIG. 4 shows a perspective view of a portion of the conveyor washing apparatus of FIG. 1 with a perforated catch tray removed from the housing of the washing system according to an example.

FIG. 5 shows a top plan view of the perforated catch tray according to an example.

FIG. 6 shows an illustration of a second example of a conveyor washing apparatus in accordance with the subject invention in association with a conveyor system.

FIG. 7 shows a sectional view of the housing associated with the conveyor washing apparatus of FIG. 6.

FIG. 8 shows a perspective view of the housing and catch tray associated with the conveyor washing apparatus of FIG. 6 with the perforated tray removed from the housing.

FIG. 9 a top plan view of the perforated catch tray according to the example of FIG. 8.

FIG. 10 shows a sectional view of a further example of a washing system according to the invention.

### DETAILED DESCRIPTION OF THE INVENTION

Various examples of the invention will now be described with reference to the figures. The spirit and scope of the invention is not limited to the examples selected for illustration. Furthermore, the apparatus may vary as to construction and details of the parts, without departing from the concepts as disclosed herein.

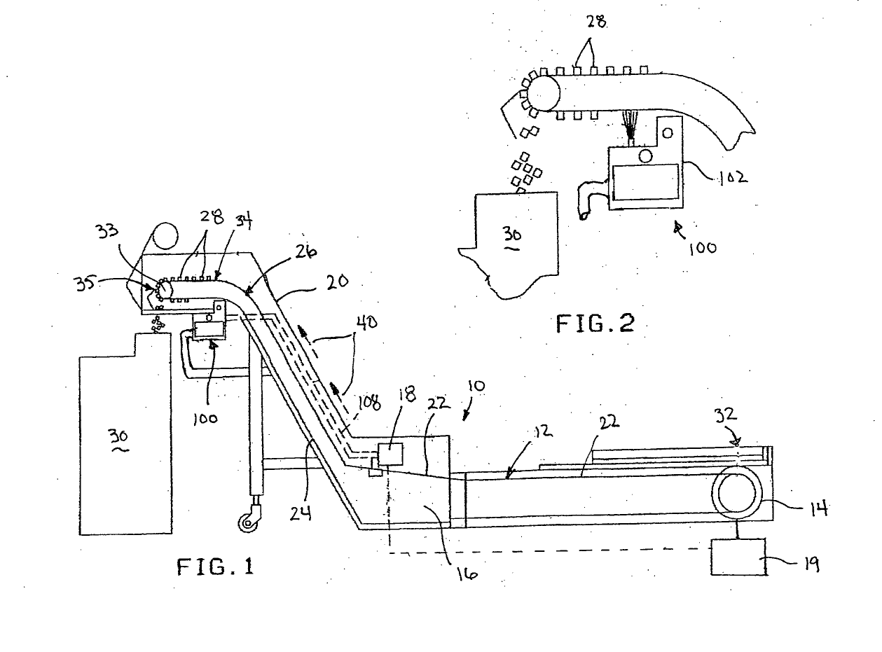

Turning to FIG. 1, a conveyor system 10 with a conveyor washing apparatus 100, according to a first example, is illustrated schematically. It should be understood that in the example shown, the conveyor system is a swarf conveyor that is used in association with a machine tool, with the machine tool generally having a source of coolant and a pumping system associated therewith, with the conveyor system 10 provided to remove swarf or metal shavings or filings or other debris. Though the reservoir and pump systems for the coolant used in the machining process are discussed in association with the conveyor system 10, it should be understood that the systems are each associated with a machine tool or the like, and the FIGS. are a schematic representation of these systems without showing the machine tool itself for clarity. The conveyor system 10 as shown in FIG. 1 is a swarf conveyor for use in association with a metal machining system (not shown), but the washing system 100 may be used with other conveyor systems if desired. The conveyor system 10 generally comprises components or assemblies including a conveyor belt 12, a motor 14 for driving the conveyor belt 12, a reservoir 16 for containing coolant fluids for use in the machining operation, and a pump 18 for supplying coolant fluids to the location of the machining tool(s). A control system 19 may be provided for operation of the various systems of the conveyor system 10. Other systems or components may also be a part of the conveyor system 10, such as an inverter for driving motor 14, a parameter programming unit, a computerized numerical control system or other systems or components. The conveyor system 10 may include a belt-guiding track (not shown), and a belt cover or housing 20 if desired. As seen, the conveyor belt 12 may include an upper run 22, and a lower return run 24. The conveyor belt 12 may also include an upwardly directed section 26 which conveys the swarf 28 upwardly at an inclined angle (e.g. 45 degrees) to then be dumped into a large bin 30, located at its elevated discharge end 35. Referring specifically to FIG. 1, it can be seen that the conveyor belt can be run continuously in the direction of arrows 40, to move swarf collected at a loading end 32 along a path including a first horizontal section and inclined section 26 and to a further horizontal section 34 to the exit or discharge end 35. The belt 12 then travels along the return path or run 24 back to the loading end. The belt 12 may run through the coolant fluid reservoir 16, and it is desirable to prevent swarf from contaminating the coolant fluid reservoir 16.

The conveyor belt 12 can be of any suitable design, and may generally be a continuous belt that is directed along upper path 22 by suitable support, such as a channel or pan, and around a motor shaft at an end, such as end 32, and passes to return path 24 around a hub 33 at end 35 for example. Belt 12 may also be configured to rest on, and be supported by runners or guides if desired. The motor 14 may be a three-phase squirrel cage induction motor or any other suitable motor for driving the conveyor belt 12. If desired, the motor 14 may allow movement of the conveyor 12 in either a forward or reverse directions, and at high, medium and/or low speeds. Motor 14 is suitably linked to belt 12 to provide a rotational driving force thereto. Therefore, when motor 14 operates in either the forward or reverse directions, the motor causes belt 12 to move accordingly, conveying belt 12 in either forward or reverse directions.

The washing system 100 is shown in FIGS. 1 and 2 to be positioned adjacent the return belt run 24 proximate to the exit end 35 of the upper conveyor run 22. In this position, the swarf 28 that has not fallen off of conveyor 12 into the bin 30 may be removed before following the return path 24 to any significant extent, thereby avoiding problems that may occur if it were to remain on the conveyor 12. Further, the position of the system 100 also captures a significant portion of the coolant fluids used in the machining process for recovery of such fluids. As may be understood, the machining process uses coolant fluids which reduce the heat generated in the machining process and also facilitate removal of the swarf from the machining site. The coolant fluids are generally deposited on the conveyor belt 12 along with the swarf or other debris, and are conveyed to the discharge end 35 along with the debris. Generally, some fluid may drip into the bin 30 at the discharge end 35 or in association with swarf or debris that falls into bin 30, but a significant amount of such coolant fluid is captured by the wash system 100 as the conveyor continues to move past the discharge end 35. In this way, the loss of coolant fluids is minimized, and coolant fluids are recovered and recirculated to the reservoir 16 in a desired manner. Further, by removal of swarf or other debris from the belt 12, such debris is not returned to the reservoir 16. As seen, the conveyor return path 24 is positioned in the reservoir 16, and any swarf that would remain on the conveyor 12 would generally fall off into the coolant fluid in the reservoir 16, thereby contaminating the fluid. Further, swarf deposited in to the reservoir 16 could also tend to clog pumping systems and conduit used in supplying the coolant fluid to the site of machining in association with one or more CNC machines or the like. By positioning the washing system 100 at this location, the swarf 28 that may be retained on conveyor 12 is removed by washing system 100 and captured for recycling or disposal. The location of washing system 100 just after collection of swarf 28 by falling into bin 30, ensures that any retained swarf 28 on the conveyor 12 is removed virtually immediately after it would normally fall off into the bin 30, and before following the return path 24 down the inclined section 26. For other applications, such as with conveyor systems used in agricultural, food processing, recycling or the like, other locations for system 100 may be suitable.

Referring to FIGS. 1-5, an example of the washing system 100 is shown, and includes several different components. The system 100 may be integrally formed in conjunction with the machine 10 or may comprise a separate system that is retrofit into use with machine 10. The washing system 100 may include a housing 102 positioned below the conveyor return path 24. In this way, any swarf or other materials dislodged by the washing system 100 fall into the housing 102 to be captured for recycling or disposal. The system 100 further includes at least one spray manifold 104 positioned adjacent the belt 12, and dimensioned to extend across substantially the entire width of belt 12. In the example shown, a single spray manifold 104 is positioned at the top portion of the housing 102 at approximately the center thereof. The spray manifold 104 has a plurality of spray nozzles 106 provided in spaced apart positions to spray substantially the entire belt 12 in conjunction with one another. The spray manifold 104 is coupled to a source of fluid which is pumped thereto via a conduit or pipe 108, to force the fluid from the plurality of spray nozzles 106 under pressure and against the conveyor 12 with force sufficient to dislodge retained swarf or other materials therefrom. If desired, a valve 109 may be provided in association with pipe 108 to selectively turn off or control the supply of washing fluid to the manifold 104. The spray nozzles 106 may be a plurality of multi-directional spray nozzles which allow the spray characteristics from the spray nozzles 106 to be varied as may be desired. In an example, the spray nozzles 106 provide a fan type spray pattern, with the spacing between spray nozzles 106 allowing the sprayed solution 110 from each nozzle 106 to overlap, thus covering the entire area of the conveyor 12 designated to be washed. The spray nozzles 106 may be positioned one to five inches from the conveyor belt 12 for example, or at other suitable distances as may be desired. The fluid 110 may be sprayed under pressure in operation, with the fluid pumped to the manifold 104 by a suitable pump system 18 is shown in FIG. 1, and may be the same pumping system provided with the conveyor system 10, which is provided to pump coolant fluid from reservoir 16 to the site of a machining operation. The fluid 110 may be the coolant fluid used in the machining operation, such that the systems and components of the conveyor system 10 are also used to facilitate the cleaning or washing of the conveyor 12 via the washing system 100. As an example, the conveyor machine pump 18 used to pump coolant to the machining operation may be a 65 pounds per square inch (PSI) pump, with sufficient capacity to provide fluid 110 under pressure to the spray manifold 104 and from the spray nozzles 106 with sufficient pressure to thoroughly wash and clean the conveyor 12 as desired. Any suitable pump 18 may be used, and the pump pressure may vary depending on the needs of the application or user. Thus, the same fluid 110 that is provided in reservoir 16 may be pumped from the conveyor machine's reservoir 16 through conduit or piping 108 to the manifold 104, where the solution 110 is sprayed against the conveyor 12, thus cleaning any retained swarf or other materials 28 from the conveyor machine's belt 12. Further, the operation of the washing system 100 to apply the cleaning solution 110 may be controlled by the control system 19 of the conveyor system 10 if desired. In this manner, the same systems used in the operation of the conveyor system 10 may also be used in operation of the washing system 100, thereby making the integration of system 100 both simple and cost-effective. For example, operation of the washing system may be controlled to only provide washing of the conveyor 12 when a machining operation is producing swarf, or while conveyor 12 is moving or the like. Alternatively, as will be described in other examples, the washing system 100 may include a separate reservoir, cleaning fluid, pumping system, control system or other components if desired, rather than using the same components or materials (coolant fluid) that may already be provided in association with conveyor system 10. Other suitable cleaning fluids may be used for example, such as water or the like, which may also be recirculated in the washing system. In operation, in this example, the cooling fluid already in the system 10 is used in the cleaning operation as described, and once sprayed against belt 12, either falls into the housing 102 or onto the bottom of the conveyor system 10, where it is returned or recirculated to the reservoir 16. Upon washing fluid falling into housing 102, a drain 116 may be provided to circulate the fluid 110 back to the reservoir 16. There may be provided filtration system in the drain line if desired to filter particles from the coolant being returned to the reservoir, or the coolant may other wised be treated or reconstituted in other manners if desired. The drain 116 may be coupled to a conduit or pipe to return the coolant back to the reservoir.

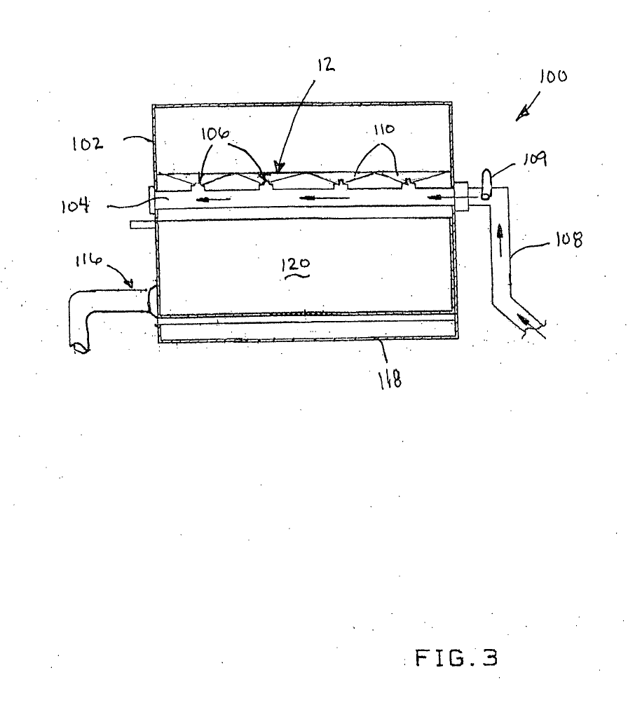

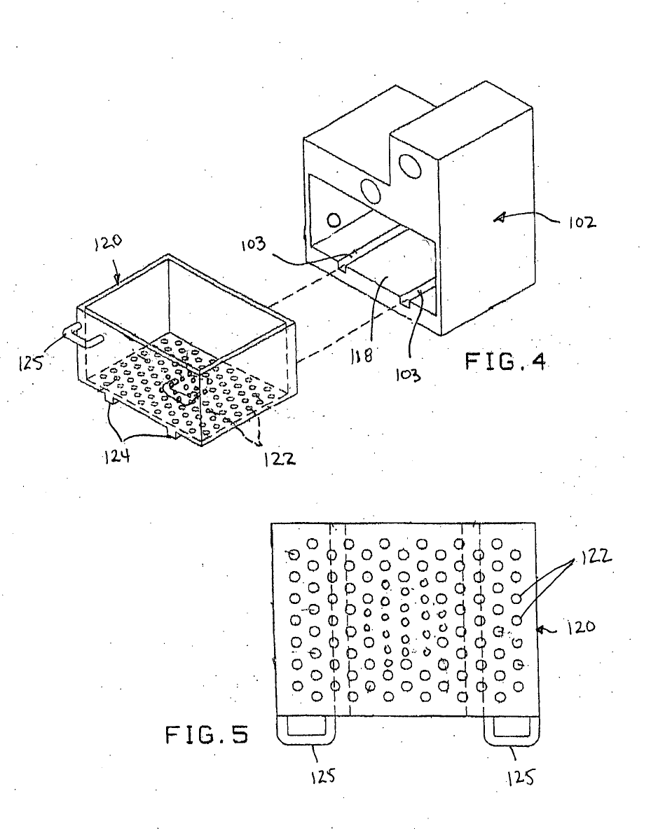

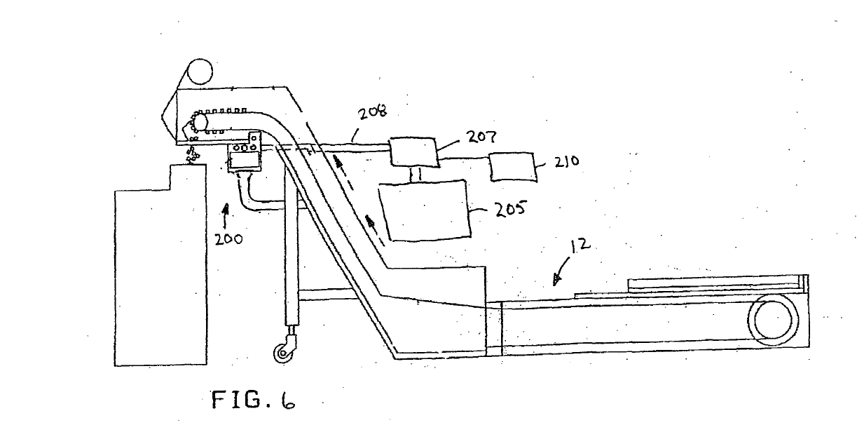

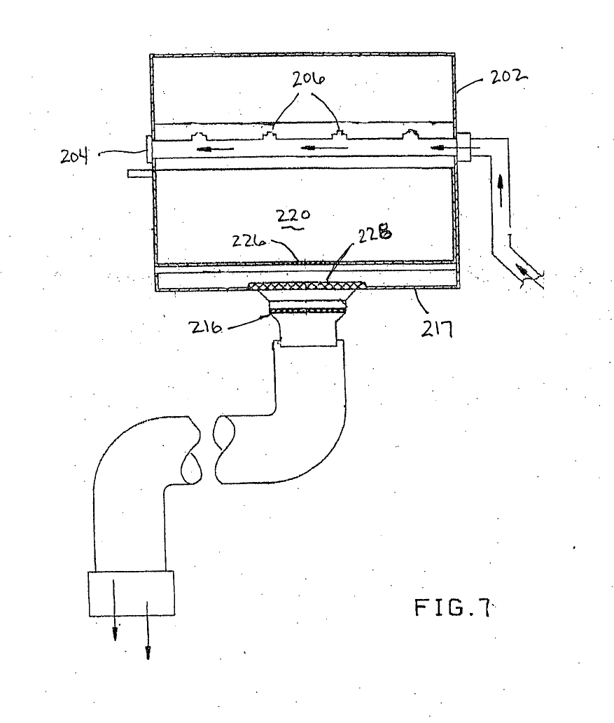

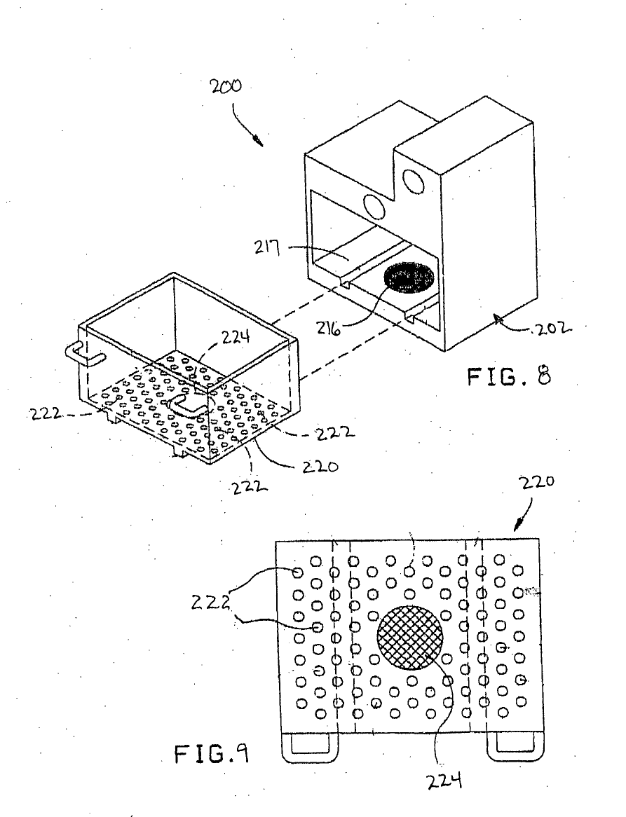

As seen in FIGS. 3-5, after spraying against the conveyor belt 12, the coolant/cleaning fluid 110 along with swarf 28 or other materials falls into housing 102 and is collected. The drain 116 may be positioned on a side wall of the housing 102 at a position above the bottom wall 118, such that fluid 110 collects until it reaches the level of the drain 116. In this way, any swarf 28 or other materials sink to the bottom wall 118, and will be inhibited from flowing out through drain 116. To collect the swarf 28 or other materials, the washing system 100 may further include a catch tray 120, formed to catch and collect the swarf 28 while allowing the cleaning fluid 110 to pass therethrough and be recirculated back to reservoir 16. The catch tray 120 may be formed as a filter tray for example, with a plurality of holes 122 or as a mesh type configuration. The catch tray 120 may be made to be selectively removable from housing 102, to allow collected swarf 28 or other materials to be periodically removed as seen in FIG. 4, and recycled or dumped as desired. To facilitate this, the housing 102 may have one side open to receive the catch tray 120, and may have guides 103 for mating with rails 124 on tray 120 for example. Any other suitable arrangement for enabling the catch tray to be selectively positioned in housing 102 and removed as needed may be used and is contemplated. In operation, if the catch tray 120 needs to be dumped, the operation of the washing system 100 may be suspended by closing valve 109 to stop the spray of fluid 110, and the catch tray 120 may be removed using handles 125, and dumped and then replaced for resumption of the washing operation. To further prevent the possible ingress of swarf 28 or other materials back to the cooling fluid reservoir 16, there may also be provided a filter (not shown) in association with drain 116 if desired.

Another example of a system according to the invention is shown in FIGS. 6-9. In this example, the washing system 200 may have its own systems instead of using components or materials of the conveyor system 10. The washing system 200 may again be integrally formed in conjunction with the machine 10 or may comprise a separate system that is retrofit into use with machine 10. The washing system 200 may again include a housing 202 positioned below the conveyor return path 24. The system 200 further includes at least one spray manifold 204 positioned adjacent the belt 12, and dimensioned to extend across the entire width of belt 12. In the example shown, a plurality of spray manifolds 204 are positioned at the top portion of the housing 202 adjacent approximately the center thereof. The spray manifolds 204 may each have a plurality of spray nozzles 206 provided in spaced apart positions to spray the entire belt 12 in conjunction with one another, with adjacent manifolds 204 having nozzles that are offset with respect to one another. The spray manifolds 204 are each coupled to an independent source 205 of cleaning fluid which is pumped thereto via a separate pump 207 and conduit or pipe 208, to force the fluid from the plurality of spray nozzles 206 into each manifold 204 under pressure. The cleaning fluid sprays from each nozzle 206 against the conveyor 12 with force sufficient to dislodge retained swarf or other materials therefrom. If desired, a valve may again be provided in association with pipe 208 to selectively turn off or control the supply of washing fluid to the manifolds 204. The spray nozzles 206 may again be a plurality of multi-directional spray nozzles which allow the spray characteristics from the spray nozzles 206 to be varied as may be desired. The spray nozzles 206 provide a spray pattern in conjunction with others on the same or other manifolds 204, to allow the sprayed solution to fully clean the entire area of the conveyor 12 and to fully wash the conveyor 12 of any debris. The spray nozzles 206 may be positioned at a suitable distance from the conveyor 12 as may be desired. The cleaning fluid may be sprayed at a desired pressure in operation, with the pump system 207 providing the desired spray pressure. The cleaning fluid may be water, with or without a detergent, or other suitable fluid. The operation of the washing system 200 to apply the cleaning solution may be controlled by a separate control system 210. In this manner, the washing system 200 may be retrofit into use with a conveyor system 10 as a package or plug-and-play type system, thereby making the integration of system 200 simple and efficient. In operation, as in the prior example, the cleaning fluid after being sprayed against belt 12 falls into the housing 202, where it is returned or recirculated to the reservoir 205. A drain 216 may be provided to circulate the cleaning fluid back to the reservoir 205.

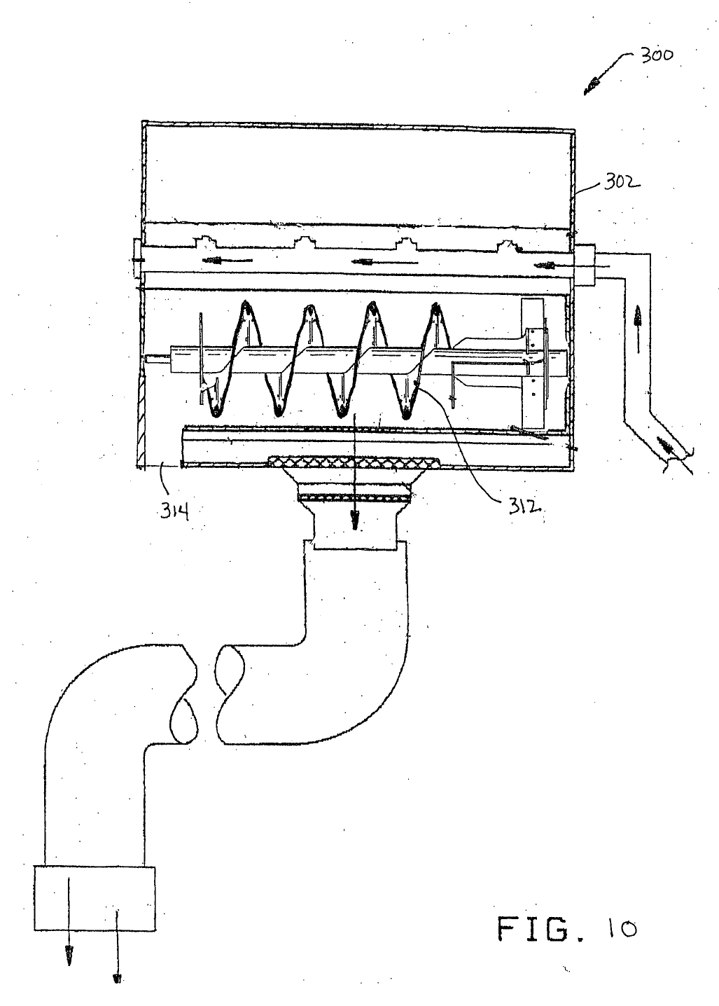

As in the prior example, after spraying against the conveyor belt 12, the cleaning fluid along with swarf 28 or other materials falls into housing 202 and is collected. The drain 216 may be positioned on a bottom wall 217 of the housing 202 at approximately the center thereof, with bottom wall 217 being sloped to urge the fluid toward drain 216. To collect the swarf 28 or other materials, the washing system 200 may again include a catch tray 220, formed to catch and collect the swarf 28 while allowing the cleaning fluid to pass therethrough and be recirculated back to reservoir 205. The catch tray 220 may be formed similar to the previous example, such as a filter tray for example, with a plurality of holes 222 or as a mesh type configuration. As seen in FIGS. 8 and 9, the catch tray 220 may have a hole 224 corresponding to the drain 216, and a filter or mesh 226 may be disposed over the hole 224 to prevent any debris from falling into the drain 216. Further, a filter or mesh 228 may be provided over the opening of drain 216 into housing 202. The catch tray 220 may again be made to be selectively removable from housing 202, to allow collected swarf 28 or other materials to be periodically removed as seen in FIG. 8, and recycled or dumped as desired. The housing 202 may again have one side open to receive the catch tray 220, and be positioned in the housing 202 in a manner similar to the prior example or other suitable arrangement for enabling the catch tray to be selectively positioned in housing 202 and removed as needed. In operation, if the catch tray 220 needs to be dumped, the operation of the washing system 200 may again be suspended by closing a valve (not shown) to stop the spray of cleaning fluid, and the catch tray 220 may be removed using handles 225, and dumped and then replaced for resumption of the washing operation. The conveyor washing apparatus 200 may be controlled using the separate control system 210 or the conveyor machine's control system as in the prior example. The control system 210 may control pump on/off, pump pressure, or other variables or functions as may be desired.

Referring to FIG. 10, another non-limiting embodiment of the conveyor washing apparatus 300 is shown, with many features being similar to that described in prior embodiments. In this example, instead of a removable catch tray, there may be provided a debris removal system 310 with the system, to intermittently or continuously remove debris from the catch tray or housing of the system. In the example shown in FIG. 10, the debris removal system 310 may comprise an auger system in association with housing 302 that is selectively operated to convey debris collected in housing 302 out from housing 302. The auger 312 may be located in a filter housing that will collect debris removed from conveyor 12 and be urged therefrom by rotation of the auger 312. Such an arrangement, or other suitable arrangement allows selective removal of debris without removal of a catch tray or the like as in prior examples. For example, instead of an auger 312, there may be a conveyor system in the housing 302, or the bottom wall of the housing 302 could be sloped and flushed to selectively remove debris therefrom, or other suitable examples are contemplated. In operation of this example, as the swarf or other debris materials are washed from the conveyor belt 12 and collected into the collecting container 302, the auger 312 may automatically remove the materials from the collecting container 302 by pushing the materials toward a discharge opening 314. The use of the auger 312 or other suitable system, provides a self-cleaning mechanism that may eliminate the need to use the perforated catch tray for example. The user of the washing apparatus 300 may then not have to stop the washing system 300 to remove and clean the perforated catch tray as in prior examples. The auger 312 may be controlled by the conveyor machine's 10 control system or by the washing system 300 control system (not shown) as may be desired.

The washing apparatus according to the invention may be integrated into a conveyor system or retrofitted to a specific conveying machine as described, thereby allowing use with existing machines or originally manufactured machines. Additionally, in another non-limiting embodiment, the washing apparatus may be portable. A portable washing apparatus may allow the user to easily move and use the conveyor washing apparatus from one conveyor machine to another.

The foregoing description of the embodiments of the invention is by way of example only, and other variations of the above described embodiments are provided by the subject invention. The embodiments presented herein have bee presented for purpose of illustration and are not intended to be exhaustive or limiting. Many variations and modifications are possible in light of the foregoing teaching.

What is claimed is:

1. A conveyor washing apparatus comprising a housing for positioning adjacent a portion of a conveyor, the housing being dimensioned to extend across substantially the width of the conveyor, and having at least one spray manifold positioned therein and extending widthwise across the conveyor, the at least one spray manifold having at least one spray nozzle and being coupled to a source of washing fluid under pressure to spray the washing fluid against the conveyor to remove debris therefrom, wherein debris removed from the conveyor falls into the housing, the housing further including at least one drain to allow washing fluid to drain therefrom.

2. The conveyor washing apparatus of claim 1, wherein the housing is selectively positioned adjacent the return path of the conveyor at the discharge end of the conveyor.

3. The conveyor washing apparatus of claim 1, wherein the source of washing fluid is a coolant fluid used provided in a reservoir of the conveyor system.

4. The conveyor washing apparatus of claim 3, wherein the conveyor system is a swarf conveyor used to remove swarf from a machining operation, and the coolant fluid is used in the machining operation.

5. The conveyor washing apparatus of claim 1, wherein the source of fluid under pressure is controlled by a pump system to supply the washing fluid to the at least one manifold at a predetermined pressure.

6. The conveyor washing apparatus of claim 5, wherein the pump system is associated with the conveyor system.

7. The conveyor washing apparatus of claim 1, further comprising a control system to control the supply of the washing fluid under pressure to the at least one manifold.

8. The conveyor washing apparatus of claim 7, wherein the control system is associated with the conveyor system.

9. The conveyor washing apparatus of claim 1, further comprising a perforated catch tray for retaining debris removed from the conveyor.

10. The conveyor washing apparatus of claim 9, wherein the catch tray is selectively removable from the housing.

11. The conveyor washing apparatus of claim 1, further comprising a debris discharge system associated with the housing to selectively discharge debris removed from the conveyor that falls into the housing.

12. The conveyor washing apparatus of claim 11, wherein the debris discharge system is an auger system that is selectively operated to discharge debris from the housing.

13. The conveyor washing apparatus of claim 1, further comprising a conduit coupled to the at least one drain to circulate the washing fluid back to the source of washing fluid.

14. The conveyor washing apparatus of claim 1, wherein the washing apparatus is integrated into a conveyor system or retrofitted with a conveyor system.

15. A method of washing a conveyor comprising
providing a washing apparatus including a housing dimensioned to extend across substantially the width of a conveyor, and having at least one spray manifold and at least one drain provided in association with the housing, the at least one spray manifold having at least one spray nozzle associated therewith,
positioning the housing adjacent the conveyor with the at least one spray manifold extending widthwise across the conveyor belt,
pumping a source of washing fluid under pressure to the at least one spray manifold to spray the washing fluid against the conveyor through the at least one spray nozzle to remove debris from the conveyor, wherein debris removed from the conveyor falls into the housing, and the washing fluid is removed from the housing through the at least one drain.

16. The method of claim 15, wherein the housing is selectively positioned adjacent the return path of the conveyor at the discharge end of the conveyor.

17. The method of claim 15, wherein the source of washing fluid is a coolant fluid provided in a reservoir of the conveyor system.

18. The method of claim 15, wherein the washing apparatus is integrated into a conveyor system or retrofitted with a conveyor system.

19. The method of claim 15, wherein the conveyor system is a swarf conveyor used to remove swarf from a machining operation, and the washing fluid is the coolant fluid is used in the machining operation.

20. The method of claim 15, wherein the pumping of washing fluid uses a pump system associated with the conveyor system.
